(19) United States
(12) Patent Application Publication
(10) Pub. No.: US 2018/0117444 A1
(43) Pub. Date: May 3, 2018

(54) METHOD AND APPARATUS FOR DELIVERING A MESSAGE TO AN ATHLETE DURING PLAY

(71) Applicant: On Field Inspiration, LLC, Attleboro, MA (US)

(72) Inventor: Catherine R. Killough, Attleboro, MA (US)

(73) Assignee: On Field Inspiration, LLC, Attleboro, MA (US)

(21) Appl. No.: 15/568,949

(22) PCT Filed: Apr. 24, 2016
(86) PCT No.: PCT/US16/29087

§ 371 Date: Oct. 24, 2017

Related U.S. Application Data
(60) Provisional application No. 62/152,769, filed on Apr. 24, 2015.

(51) Int. Cl. A63B 71/06; G09F 23/00; G09F 27/00; G09F 21/02

(52) U.S. Cl. CPC A63B 71/0622; G09F 23/0066; G09F 27/00; G09F 21/02; A63B 2102/02; A63B 2071/063; A63B 2071/0655; A63B 2071/0694; A63B 2071/0625

(57) ABSTRACT

A system that incorporates teachings of the subject disclosure may include, for example, a device that includes a supporting member having an outer edge and an exposed surface having a shape defined by the outer edge. The supporting member is attachable to a personal sports equipment item. The device further includes a message attached to the supporting member and an attachment feature positioned at a location on the supporting member. One of the attachment feature, the location, the shape or a combination thereof is based on a configuration of the personal sporting goods item. Other embodiments are disclosed.

### CROSS-REFERENCE TO RELATED APPLICATIONS

This application claims priority to U.S. Provisional Patent Application Ser. No. 62/152,769 filed Apr. 24, 2015. The contents of the foregoing are hereby incorporated by reference into this application as if set forth herein in full.

### FIELD OF THE DISCLOSURE

The subject disclosure relates to a method and apparatus for delivering a message to an athlete during play.

### BACKGROUND

Achieving a measure of success in competitive athletics requires a combination of many factors. These include physical conditioning, skills development and mental focus. Lacking in any one can lead to sub-par performance. Arguably, success on the athletics court or field also requires coaching and feedback. Despite adequate physical conditioning and skills, even a momentary lapse of focus can produce undesirable results.

To help athletes maintain focus, coaches, team mates and other supporters often provide words of encouragement. This might include instructions on the sidelines, comments in the huddle, and occasional shouts from team mates and other supporters. Ideally, the athlete is able to react positively to such reinforcements and perform to the best of his/her abilities at all times.

### BRIEF DESCRIPTION OF THE DRAWINGS

Reference will now be made to the accompanying drawings, which are not necessarily drawn to scale, and wherein:

FIG. 1 depicts an illustrative embodiment of a sports message accessory item kit;

FIG. 2 depicts an illustrative embodiment of an accessorized softball/baseball glove including the sports message accessory item kit of FIG. 1, mounted thereon;

FIGS. 3A-3C depict photographs of an illustrative embodiment of a softball/baseball glove fitted with another glove accessory;

FIG. 4A-4B depict photographs of another illustrative embodiment of a softball/baseball glove fitted with yet another glove accessory;

FIG. 5 depicts an illustrative embodiment of a head end of a lacrosse stick fitted with a removable message-bearing accessory;

FIG. 6 depicts an illustrative embodiment of a tennis racket fitted with a removable message-bearing accessory;

FIG. 7 depicts an illustrative embodiment of another message-bearing accessory; and

FIG. 8 depicts a schematic diagram of an example of an electrical circuit of the message-bearing accessory of FIG. 7.

### DETAILED DESCRIPTION

The subject disclosure describes, among other things, illustrative embodiments of a message-bearing accessory that can be removably attached to a sporting goods equipment item to provide a player with a message before, after and during the course of game play.

In some embodiments, a device includes a supporting member having an outer edge and an exposed surface having a shape defined by the outer edge. The supporting member is attachable to a personal sports equipment item. The device further includes a message attached to the supporting member and an attachment feature positioned at a location on the supporting member. One of the attachment feature, the location, the shape or a combination thereof is based on a configuration of the personal sporting goods item. Other embodiments are included in the subject disclosure.

One embodiment of the subject disclosure includes a device that includes a supporting member that includes an outer edge and an exposed surface having a shape defined by the outer edge. The shape includes an elongated straight portion terminating in a curved portion at one end, wherein the straight portion is longer than the curved portion. The device further includes a message positioned along the exposed surface of the supporting member and an attachment mechanism. The attachment mechanism is positioned at a location on the supporting member and configured to attach the supporting member to a personal sports equipment item. One of the attachment mechanism, the location, the shape or a combination thereof are based on a configuration of the personal sports equipment item.

Another embodiment of the subject disclosure includes a sports equipment accessory kit. The kit includes a substrate having an outer edge and an exposed surface having a shape defined by the outer edge. The substrate shape includes an elongated straight portion terminating in a curved portion at one end, wherein the straight portion is longer than the curved portion. The kit further includes a message that can be positioned along the exposed surface of the substrate and a fastening mechanism. The fastening mechanism includes a first fastener positioned at a location on the substrate and configured to attach the substrate to a personal sports equipment item and a second fastener configured for cooperative engagement with the first fastener to affix the substrate to a personal sports equipment item, wherein one of the fastening mechanism, the location, the shape or a combination thereof are based on a configuration of the personal sports equipment item.

Yet another embodiment of the subject disclosure includes an accessorized sports equipment item having a sports equipment item and a message-bearing accessory that is removably attached to the sports equipment item. The message-bearing accessory includes an attachment feature operable to removably attach the message-bearing accessory to the sports equipment item. The message-bearing accessory is removable and replaceable with an alternative message-bearing accessory.

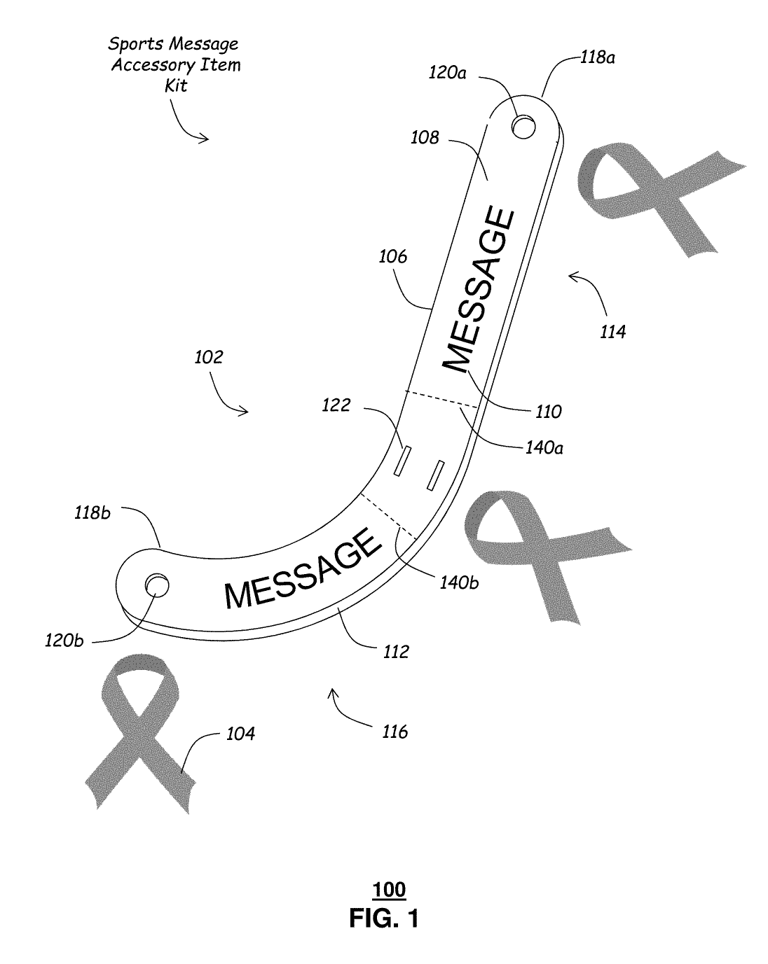

FIG. 1 depicts an illustrative embodiment of a sports message accessory item kit 100. The kit 100 includes a message-bearing accessory 102 suitable for mounting on a personal item of sporting goods equipment and lacing 104 suitable for mounting the message-bearing accessory 102 onto the sporting goods equipment item.

The message-bearing accessory 102 includes a supporting member 106, substrate, banner, badge or placard that includes an exposed surface 108 to support a message 110. The message 110 can be a visual message, including one or more of text, image, design, colors and the like. In at least some embodiments, the message 110 can include non-visual component. For example, the message 110 can include an audio message, including one or more of verbal content and non-verbal content. Verbal content can include words that articulate a particular message. Such verbal messages can include general words or phrases, such as words of encouragement or support. The verbal message can be pre-recorded and/or synthesized. The verbal message can be provided in a recognizable voice, such as the voice of a famous athlete, a coach, parent, team-member, and the like. Non-verbal audio messages can include one or more of musical tones. Such music can be pre-corded, sampled and/or synthesized and include, without limitation, songs and/or portions of songs, such as popular music, a team song or chant, national anthems and the like. It is understood that in some applications the audio message can include non-verbal, non-musical sounds, such as sound effects, e.g., including game-related noise. Such noises might include crowd cheers, jeers, a crack of a bat-on-ball, a sound of a ball hitting a glove or racket, and the like.

The exposed surface 108 can be substantially flat, providing sufficient surface area to contain a message 110 of sufficient size to be perceived easily by a player during a course of game play, when mounted on the player's personal sporting goods item. In at least some embodiments, the supporting member 106 is flexible, bendable or otherwise pliable to conform to a shape of an adjoining region of the sporting goods equipment item. Such flexibility does not interfere with any flexure of the sporting goods equipment, e.g., during game play. When mounted on a flexible portion of the sporting goods item, the supporting member flexes along with the sporting goods item so as not to interfere with normal operation thereof.

Without any particular restriction to shape, the exposed surface 108 can extend between one or more edges 112 of the supporting member. The edges 112 can be fashioned to provide an overall shape to the supporting member 106, and in particular to the exposed surface 108. The edges 112 can be linear, piecewise linear, curvilinear, or any combination of linear, piecewise linear and curvilinear. The shape of the exposed surface 108 as defined by the edges 112 can be a regular polygon, as in a triangle, a rectangle or a square, an irregular polygon, an ellipse or a circle, or any conceivable shape that might otherwise be suitable for a particular application. Suitability can be determined according to one or more factors, including size, shape, thickness, and so on.

It is understood that such personal sporting goods items generally serve a function relevant to the course of game play. Moreover, features of such personal sporting goods items, e.g., dimensions, shapes, materials, are often governed by league rules, such as NCAA (National Collegiate Athletic Association) rules for collegiate players or FIL (Federation of International Lacrosse) rules for international players. In at least some embodiments, any personal sporting goods equipment that satisfies governing league rules will continue to do so after being accessorized with the sports message accessory item kit.

It is also understood that not every application will be governed by league rules, e.g., “sand lot” or “school yard” play. Accordingly, it is envisioned that some personal sporting goods equipment that satisfy governing league rules will not continue to do so after being accessorized with the sports message accessory item kit. Nevertheless, the accessorized personal sporting goods equipment will continue to support safe game play, preferably without adversely altering functionality or performance of the sporting goods equipment item.

In the illustrative example, the exposed surface 108 has an elongated shape having a substantially straight portion 114 and a contoured portion 116. The substantially straight portion 114 extends in along a transverse direction between generally parallel edges 112, and along an axial direction between a first end 118a of the supporting member 106 and the contoured portion 116. The contoured portion 116 extends in a non-linear, or contoured direction between two edges 112 aligned along a shape of the contour. Although opposing edges 112 of the supporting member 106 are disclosed as being aligned, as in the illustrative example, it is envisioned that such edges need not be aligned. For example, one or more portions of the supporting member 106 can include a taper, and/or non-linear edge 112, as in an edge-shape design, e.g., a scalloped edge, triangular or saw-tooth edge, and the like. The contoured portion 116 extends from an adjacent end of the substantially straight portion 114 to a second end 118b of the supporting member 106. Such elongated shapes are beneficial to supporting textual messages, e.g., with minimal excess exposed surface. A message can be applied to an exposed surface of the substantially straight portion, the contoured portion or both portions, as illustrated. The message 110 can be a singular message as in a word, e.g., a name, or a phrase. The message 110 can be a compound message, e.g., with multiple words or phrases, designs, colors, and the like.

The supporting member 106 includes a number of first attachment features. In particular the supporting member 106 includes a first aperture, e.g., an eyelet 120a, at the first end. The eyelet 120a defines an aperture extending from the exposed surface 108 to an underside of the supporting member. The underside defines a mounting, or abutting surface that faces an adjoining region of the sporting goods equipment item when mounted thereon. The supporting member 106 includes a second aperture, e.g., another eyelet 120b, at the second end 118b and defining an aperture extending from the exposed surface 108 to the mounting surface. In operation, a first lacing 104 extends through the first aperture 120a and a portion of the sporting goods equipment item. The first lacing, when tied therethrough forms an attachment at the first end 180a. Likewise, a second lacing 104 extends through the second aperture 120b and another portion of the sporting goods equipment item. The second lacing 104, when tied therethrough forms an attachment at the second end 108b.

The supporting member 106 includes another attachment feature including two parallel slots 122. The parallel slots 122 are substantially aligned with the edges 112 and define apertures extending from the exposed surface 108 to the mounting surface. A third lacing 104 is routed in a first direction through one of the parallel slots, and in a second direction through another one of the parallel slots. When so routed, the lacing 104 forms a loop that grasps a portion of the exposed surface extending between the parallel slots 122. The third lacing is threaded through an adjacent portion of the sporting goods item and a knot formed such that the third lacing keeps a mid-portion, between the first and second ends, securely attached to the sporting goods item.

Through the multiple attachments, the supporting member 106 is securely affixed to the sporting goods equipment at multiple locations. Accordingly, neither end 118a, 118b nor a mid-section of the supporting member 106 are allowed to move apart from movement of adjoining regions of the sporting goods item. Such secure mounting ensures that the message-bearing accessory 102 remains securely fastened to the sporting goods item during game play in a manner that allows for display of the message and so as not to interfere with game play. It is generally understood that more or fewer attachments can be provided according to a particular application. It is also understood that in at least some applications, it may be preferable to leave at least a portion of the supporting member unattached so as to move with respect to the sporting goods equipment item. For example, the supporting member 106 can be attached at only one end 118a, or only the mid-section to allow one or both ends 118 to move freely.

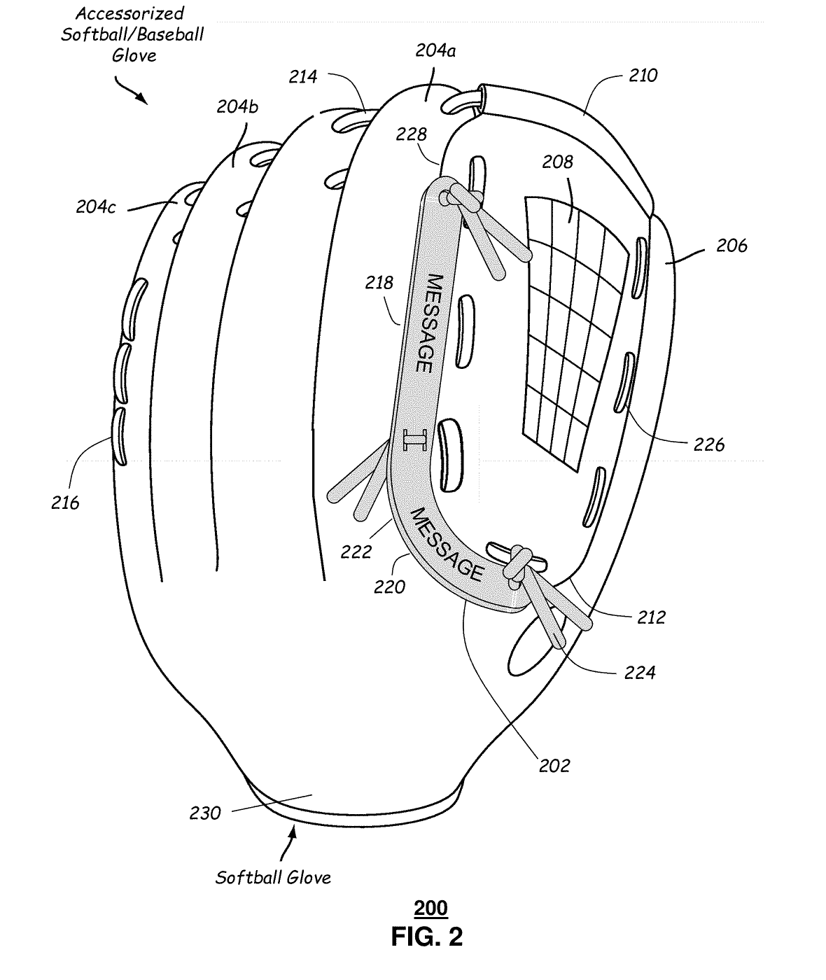

FIG. 2 depicts an illustrative embodiment of an accessorized softball glove 200 including a sports message accessory item kit 202, such as the kit 100 of FIG. 1, mounted thereon. The softball glove 200 includes a number of fingers 204a, 204b, 204c (generally 204), e.g., four fingers 204 and an opposable thumb 206. An open space between a first finger 204a and the thumb 206 contains a webbing portion 208. The webbing portion 208 extends from a bridge portion 210 at one end of the webbing portion 208, between the first finger 204a and thumb 206 tip end, to a web crotch 212 at an opposing end. Various portions of the glove 200 are attached or otherwise fashioned with lacings, e.g., finger lacings 214, pinky lacings 216, and the like. It is common for such softball or baseball gloves to be fashioned from a natural leather and/or a synthetic material, such as vinyl.

In the illustrative embodiments, a supporting member 222 of the message accessory item kit 202 is positioned along a portion of the webbing 208. As illustrated, a substantially straight portion 218 is aligned along the first finger 204a, whereas a contoured portion 220 is aligned along a portion of the web crotch 212. Such an alignment allows the supporting member to follow a seam between the webbing and the first finger. In an alternative arrangement, the supporting member can be arranged to follow a seam between the webbing and thumb.

The lacings extend through the attachment apertures of the supporting member 222, and through attachable features of the softball glove 200. For example, lacing portions 224 of the kit 202 can extend through one or more loops of web lacing 226 of the glove 200. When each of the lacings 224 is threaded as indicated and tied into a knot, it forms a closed loop that grasps the web lacing 226 of the glove and a portion of the supporting member 222. It has been found that three such attachments are sufficient to attach the message-bearing member 222 to an adult-sized glove 200. It is understood that in some embodiments a greater or fewer number of attachments, e.g., lacings 224, can be provided.

Although the example message-bearing member 222 is shown along a first finger-web seam 228, other locations are possible. For example, the message-bearing member 222 can be provided along a thumb-web seam, e.g., along a portion of the web crotch 212. Alternatively or in addition, the message-bearing member can be attached entirely along a web crotch-webbing seam, along the bridge 210, between fingers 204, across fingers 204, along the thumb 206, the pinky 204c, a wrist portion 230, and so on.

In some embodiments, messages can be textual, e.g., providing words and/or phrases relevant to a player during the course of game play. Such supportive messages can be generalized, as in “STAY FOCUSED,” “YOU'RE AWESOME” and the like. It should be understood that such supportive messages can be more specific or tailored to a particular game, e.g., “BALL FIRST” to remind a player to secure the ball in the glove before applying a tag to a base runner.

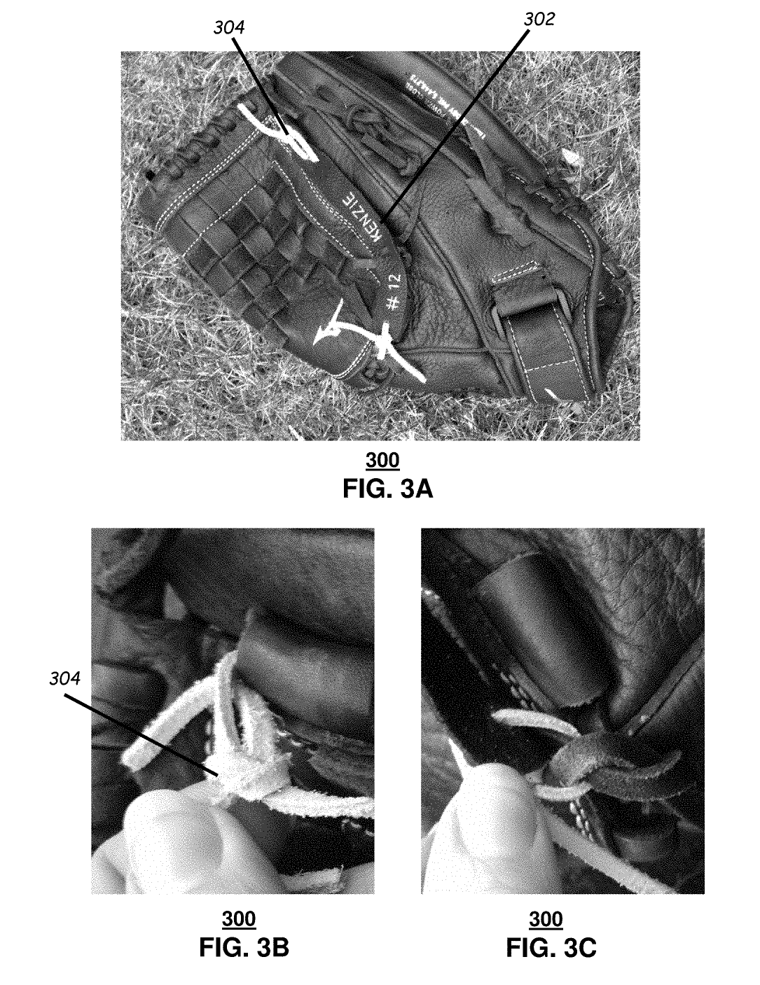

FIG. 3A depict a photograph of an illustrative embodiment of an accessorized softball/baseball glove 300 fitted with another glove accessory kit. The accessorized glove 300 includes a message-bearing member 302 positioned along a web-thumb and web-web crotch seam. FIGS. 3B and 3C show detail of lacings 304 that attach the message-bearing member to the glove 300.

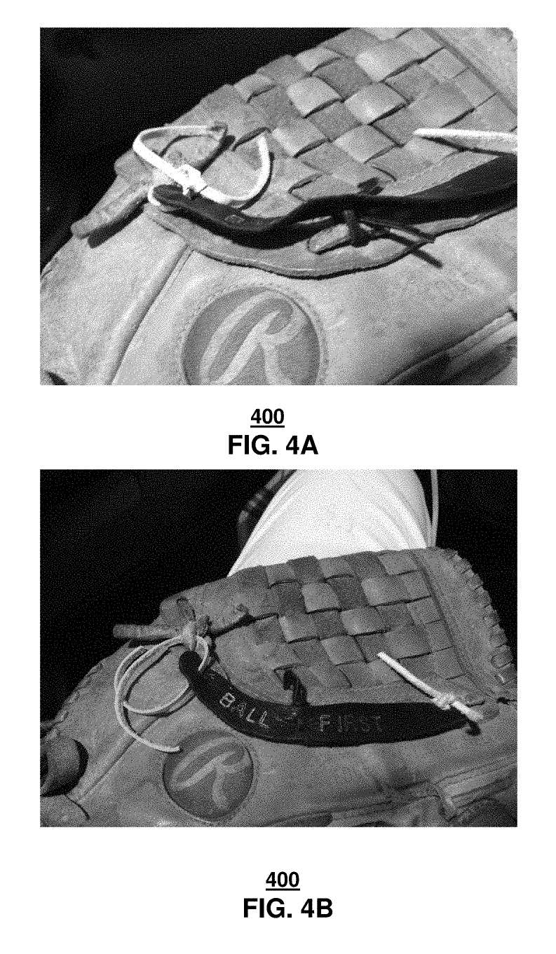

FIG. 4A-4B depict photographs of another illustrative embodiment of an accessorized softball/baseball glove 400 fitted with yet another glove accessory item kit. Details of a lacing of the mid-section of the message-bearing member are illustrated, showing how the attachment lacing attaches 304 the message-bearing member to a web lacing of the glove 300.

In some embodiments, the exposed surface is a surface of the supporting member. Alternatively or in addition, the exposed surface is a surface of a separate message-bearing member. The supporting member can be attached to the sporting goods item, while the message-bearing member can be removably attached to the supporting member. Any of the attachment techniques disclosed herein can be used to attach the message-bearing member to the supporting member. Moreover, the type of attachment provided between the supporting member and the sporting goods item can be the same as or different from the type of attachment provided between the supporting member and the message-bearing member.

By way of illustrative example, the supporting member can attach to a softball/baseball glove using the lacings, ties or straps. The supporting member can include a different attachment device, such as a portion of a hook-and-loop fastener system, a snap, a button, and so on. In particular, the first type of attachment to the softball/baseball glove can use lacings similar to those used in construction of the glove. As the lacing and re-lacing can be cumbersome, a second, simpler type of attachment, such as Velcro® hook-and-loop fastener can be used to mount or otherwise attach, detach and re-attach the message bearing member to the supporting member, and by way of the lacings, to the glove.

It is conceivable that in at least some embodiments, a traditional sporting goods item, such as a softball/baseball glove, can be manufactured or otherwise outfitted with an attachment feature. By way of an example, a softball/baseball glove can include one or more of snaps, buttons, lacings, or a portion of a hook-and-loop fastener system. The message bearing member having the exposed surface can include a corresponding attachment feature to allow for engagement with the attachment feature already provided on the sporting goods item, e.g., the glove.

In some embodiments, the message accessor kit includes fastener portions configured for secure attachment to the sporting goods item, such as a first portion of a hook-and-loop, snap, anchor or button fastening system. The first portion can attach to the sporting goods item using one or more of a glue and cleat or stitching. A corresponding portion of the fastening system can be securely attached to the supporting member to facilitate attachment and/or removal of the supporting member from the sporting goods item. It is envisioned that the attachment mechanisms can be tailored to a particular degree of attachment. Namely, the fastener can be designed to hold secure during normal play, but to release from the sporting goods item under extreme circumstances, such as a snag encountered during play. In response to a snag, the fastening mechanism allows a portion of the supporting member or all of the supporting member to separate from the sporting goods item.

In some embodiments, the supporting member itself can include one or more safety features. For example, in some embodiments, the supporting member can include one or more weakened areas 140a, 140b (generally 140). The weakened areas 140 provide supporting during normal use, but allow for a break away feature during extreme circumstances, such as during a snag. By way of non-limiting example, the weakened areas can include one or more of perforations, thinned areas, different materials, and the like.

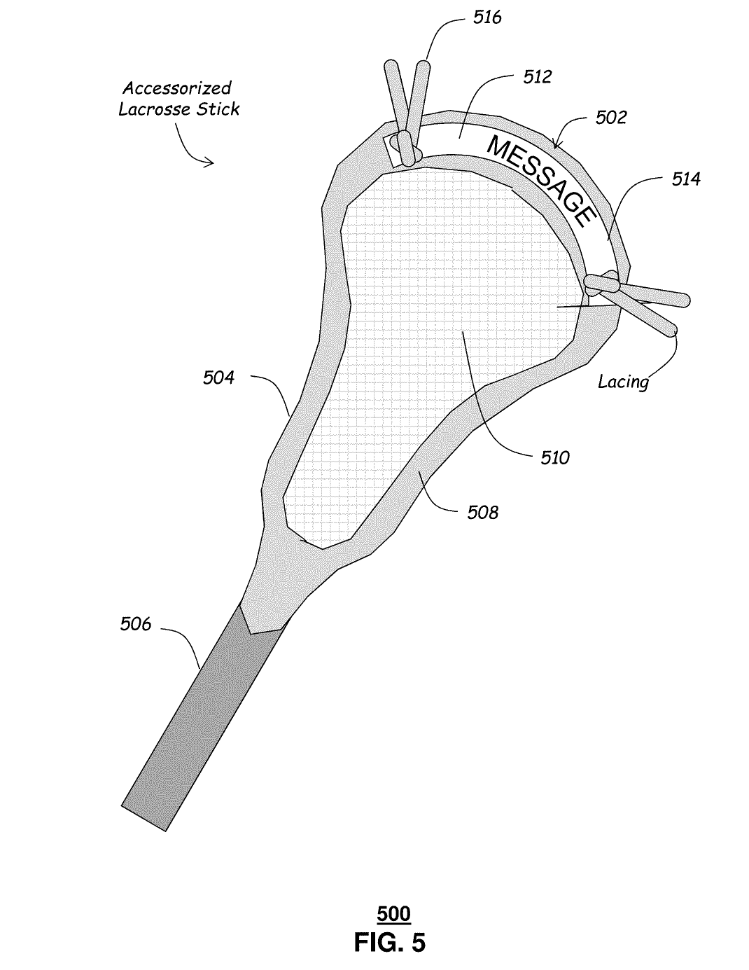

FIG. 5 depicts an illustrative embodiment of a head end of a lacrosse stick 500 fitted with a removable message-bearing accessory 502. The lacrosse stick 500 includes an elongated head 504 attached at one end of a shaft 506. The head 504 includes a frame portion 508 that defines an open region. Webbing attaches to the frame portion 508 and extends across the open region to define a pocket 510.

In this example, the message-bearing accessory 502 comprises a supporting member 512 having an exposed surface defined by an edge 514. The exposed surface has a shape that is contoured to an edge of the head portion 504. The example accessory 502 is positioned at an outer edge opposite from a point of location of the head 504 to the shaft 506. It is conceivable that the accessory 502 can have other contoured shapes to accommodate attachment to other regions of the lacrosse stick 500, e.g., along a side region of the head portion 504, at a heel region of the head portion 504, e.g., adjacent to an end of the shaft 506, along the webbing of the pocket 510, along the shaft 506, or perhaps spanning more than one region, e.g., along a portion of the head 504 and a portion of the shaft 506, and so on.

The particular materials used, messages portrayed, attachments provided, e.g., lacing 516, and so on can include any of the examples disclosed herein.

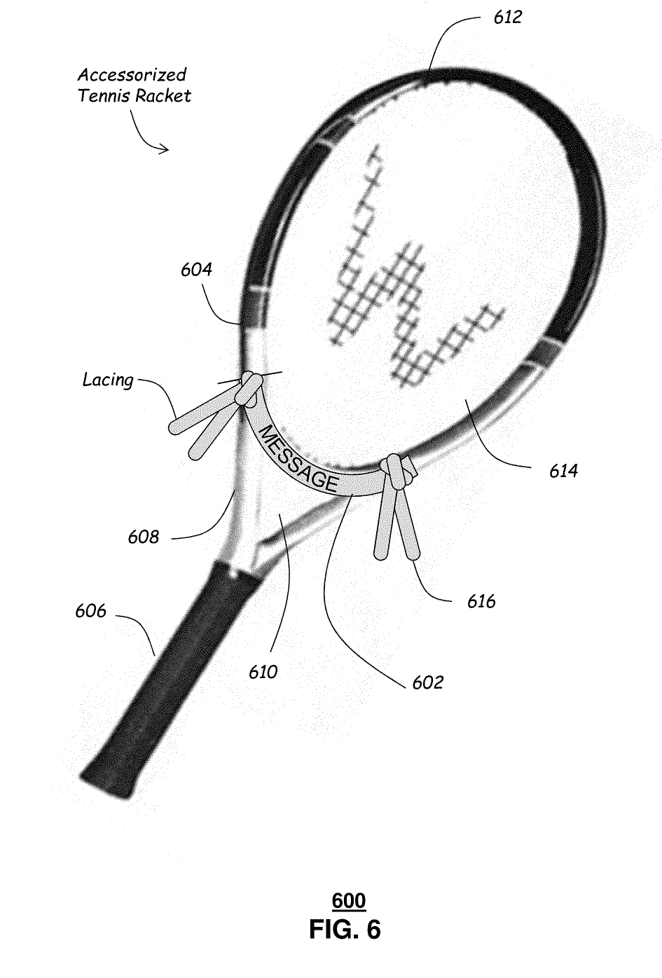

FIG. 6 depicts an illustrative embodiment of a tennis racket 600 fitted with a removable message-bearing accessory 602. The racket 600 includes a racket head portion 604 attached to a grip 606 by way of a shaft 608. In the illustrative example, the shaft 608 defines an open throat 610 section and attaches to a beam 612 of the racket head portion 604. The racket head portion 604 includes strings 614 that form webbing along an interior region defined by the beam 612.

In this example, the message-bearing accessory comprises a supporting member having an exposed surface defined by an edge. The exposed surface has a shape that is contoured to a portion racket head. The example accessory 602 is positioned at an outer edge opposite from a point of location of the head portion 604 to the shaft 608. It is conceivable that the accessory 602 can have other contoured shapes to accommodate attachment to other regions of the tennis racket 600, e.g., along a side edge of the racket head, at a heel portion of the racket head adjacent to an end of the shaft 608, along the strings 614, along the shaft 608, spanning the open throat 610, or perhaps spanning more than one region, e.g., along a region of the head portion 604 and a portion of the shaft 506, and so on.

The particular materials used, messages portrayed, attachments provided, e.g., lacings 616, and so on can include any of the examples disclosed herein.

The message-bearing accessory provides a message to an athlete during game play. The message can be inspirational, instructional and motivational. In some embodiments, such messages, e.g., phrases, are only visible to an athlete or player while on the field of play. This can include positioning of the message-bearing accessory on the sporting goods item, such that the message is only visible to the athlete using it, not others. The message can be prominent in one or more configurations of the sporting goods equipment, e.g., positioned for visibility when a softball/baseball glove is on a player's knee, while the player is running, fielding, and so on.

Such placement, sizing, coloring, etc., can be positioned to reduce or otherwise avoid wear and tear to the message-bearing accessory. Such placement, sizing, color, etc., can also be configured so as to deliver a message to one or some players while not to distract to other players. For example, a portion of the webbing and fingers of a pitcher's glove are visible to batters. This location can be chosen to deliver a message to the batter, e.g., including a message of intimidation or distraction. Alternatively this location can be avoided so as to avoid sharing a message with the batter. In such instances, the message might be displayed on another portion of the pitcher's glove, such as along in inner portion of the webbing along the bridge. It is envisioned that the supporting member can include another message along an underside of the supporting member, i.e., opposite to the exposed surface. In such circumstances, the player may choose to reverse a positioning of the supporting member to arrange an underside as an exposed surface to allow for exposure to the alternate message.

The message-bearing accessory allows a sporting goods equipment item to become customizable and/or personalized. By its removable attachment, the message-bearing accessory can be interchangeable from one sporting goods equipment item to another, e.g., one glove to another. Alternatively or in addition, different message-bearing accessories can be interchanged on the same player's sporting goods equipment item to allow for changing messages. Consider a player working on specific skills—the message-bearing accessory can include a particular instructional message to address the specific skill(s). By way of example, a player who may not be confident in tagging base runners may apply a message-bearing accessory with the instructional message “GET THE BALL FIRST.” Such a message can serve as a focus point. Accordingly, the player can observe the message during game play, providing a reminder for the player to “get the ball first” before attempting to tag the runner. Ideally, such carefully selected and positioned messages can serve the player by improving performance.

The message can include one or more of a player's name, a player's position, a player's jersey number, a team name, league, school, or other association. In some embodiments, the message can be applied, modified, customize or otherwise adorned by the player. By way of non-limiting example, the kit can include one or more of lettering, patterns, and the like configured to be applied or otherwise arranged by the player. Such lettering, patterns and the like can be provided as attachable items, e.g., attached by a glue or other adhesive. Alternatively or in addition, the message accessory item kit can include one or more other implements to apply ink, paint or the like directly to an exposed surface of the supporting member. Such examples can include pens, brushes, markers, and the like. It is envisioned that such customizing implements can be included with the accessory item kit and/or provided separately to allow players to choose colors, patterns, etc., of their liking.

Some sporting goods equipment items, such as baseball gloves or softball gloves look naked. Application of one or more message-bearing accessory items can serve to decorate the equipment item. Such adornments can include one or more of colors, shapes, e.g., logos, to display a team spirit. In some embodiments, such adornments can be purely decorative. In other embodiments, the adornments can be personalized, e.g., according to an affinity, as in a particular television program, character, celebrity, hobby, music, and so on. It is understood that some message-bearing accessories can be applied in a common manner by a team, e.g., providing accessories with team colors, team sayings, and so on. In at least some embodiments, the message-bearing accessories can recognize accomplishments, e.g., awarded to a player as merit recognition for a good performance. For example, only one member of a team may receive a message-bearing accessory based on team performance, e.g., the 10^{th} player in baseball.

Applications, without limitation can include any sporting goods equipment item having a glove. By way of non-limiting example, sports that use gloves include softball, baseball, ice hockey, including regular player and goalie gloves, field hockey, boxing, soccer (e.g., goalie), and cricket. Gloves can include batters' gloves, football gloves, and the like.

Other applications include sports that use sticks and/or rackets. By way of non-limiting example, sports that use sticks and/or rackets include lacrosse, hockey, tennis, squash, racquetball, ping pong, badminton, etc. Other applications can include sporting goods equipment items in relation to skiing/snowboarding, motocross, and apparel items, such as boots, shoes, cleats, and so on.

The message-bearing accessory can be made from materials of various properties, based on one or more of the sport, the conditions of play, league rules, and so on. For example, material properties include materials that are one or more of rigid, semi-rigid, flexible, pliable, elastic, floppy, heavy weight, light weight, solid, porous, and so on. In at least some applications materials of the message-bearing accessory are chosen to avoid one or more of interference during game play, unnecessary wear and tear of the message-bearing accessory and/or unnecessary wear and tear of the sporting goods equipment item, and so on. For example, materials that do not stretch too much, are preferred in applications that avoid the possibility of a snag and gaps.

Some example materials include, without limitation, natural materials, such as leathers, suede, rubber, wood, metal, canvass, cotton. Alternatively or in addition, materials can include synthetic materials, such as polyesters, nylon, vinyl, and the like. Materials can include woven fabrics, and non-woven fabrics. In at least some embodiments, the message-bearing member is made from the same or similar material as the sporting goods equipment item. At least one example includes a leather message-bearing member usable on a leather baseball glove, softball glove or combined softball/baseball glove.

Attachment features can include laces or ties. Laces can be made from one or more of leather lace, latigo, suede lace, shoe lace, cotton yarn, nylon, and so on. Other attachment features can include one or more of buckles, snaps, clasps, buttons, pins, hook and loop, e.g., Velcro® hook and loop fasteners and so on. Still other attachment features include mechanical fasteners, such as staples, rivets, screws, jewelry style clasps, zip ties, carabineers, quick-links and the like. Still other attachments features include chemical fasteners, as adhesive compounds, and the like. It should be understood that any of the aforementioned attachment features can be used alone or in combination.

A visual message, e.g., in the form of text, design, logo and so on can be applied to the exposed surface of the supporting member (FIG. 1) by a printing process or a stitching process. Modes of printing can include ink printing, silk screening, surface modification, e.g., laser etching, wood-burning, stamping or the like to produce, embossed, raised letters, debossed, sunken letters, numbers, logos, symbols along the exposed surface of the supporting member. In some embodiments, edging can be applied according to any of the aforementioned process, including without limitation stamping in decorative edges, laser cutting/printing, embroider and so on.

In at least some embodiments, the supporting member, and particularly the exposed surface of the supporting member are given a surface treatment or finish. Such treatments or finishes, such as leather sheen can be applied to promote durability and prohibit wear and tear.

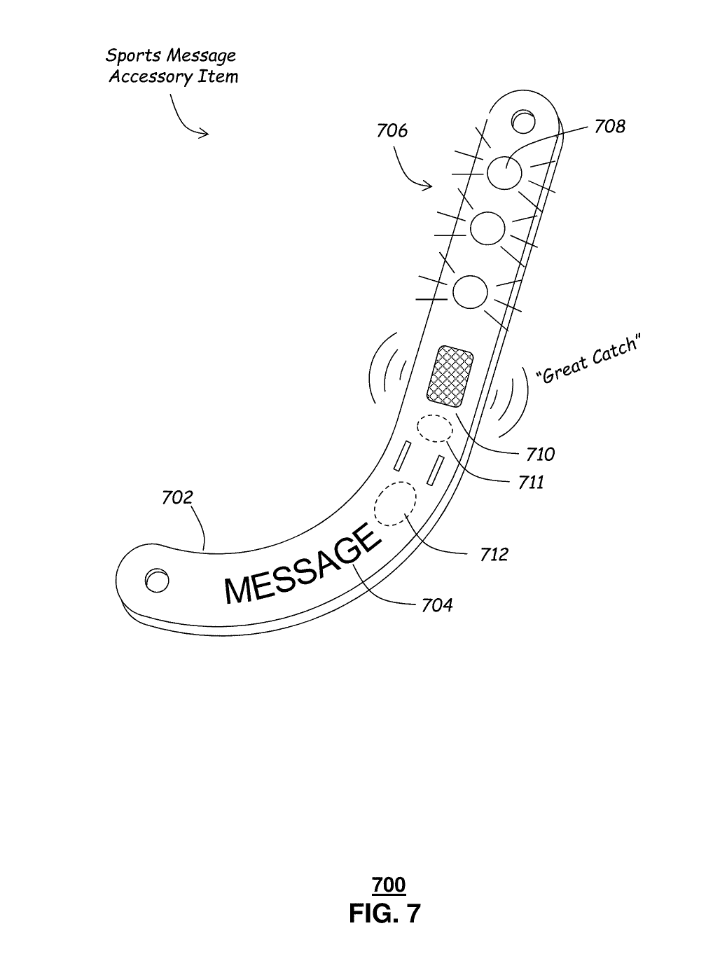

FIG. 7 depicts an illustrative embodiment of another message-bearing accessory 700. In particular, the message bearing accessory 700 includes a supporting member 702 that includes an exposed surface to support a message 704. The exposed surface can be substantially flat, providing sufficient surface area to contain a message 704 of sufficient size to be perceived easily by a player during a course of game play, when mounted on the player's personal sporting good item. The illustrative example includes, without limitation, a contoured shape, e.g., a “J” shape, suitable for mounting to a softball and/or baseball glove. It should be understood that other sizes, shapes and/or configurations can be provided based on one or more of a particular sporting equipment item, a particular application, personal choice, league rules and so on.

The message bearing accessory 700 can include a lighting arrangement 706. The lighting arrangement 706 can include, without limitation, one or more of light emitting diodes (LEDs) 708, incandescent bulbs, phosphorescent material, chemo luminescent sources, and so on. In the illustrative example, the lighting arrangement includes three LEDs. Other lighting arrangements can include symbols, letters, and/or configurable displays to provide textual and/or graphical output.

The lighting arrangement 706, e.g., the LEDs 708, can be selected and/or arranged to convey a message. For example, the LEDs 708 can provide one or more colors that convey a message, such as a team association, an affinity, a personal preference, and so on. Alternatively or in addition, one or more of a number of LEDs or positions of the LEDs 708 can be selected to convey a message. For example, the LEDs 708 can be arranged to spell out a letter and/or word. Likewise, operation of the LEDs 708 can be selected to convey a message. For example, the LEDs 708 can be configured to blink or flash on and off according to a predetermined sequence and/or timing, e.g., long and short variations in on and/or off sequencing. The sequence and/or timing of the on-off sequence can be suggestive or otherwise indicative of a message, such as a beat of a song, a rhythm of a chant and/or cheer and so on. The LEDs 708 can include different colors, allowing for a color coded message, such as a green, yellow, red, and the like.

Alternatively or in addition, the message-bearing accessory includes an audio source. The audio source can include, without limitation, one or more of an audio transducer, e.g., a speaker 710. In the illustrative example, the audio source includes a speaker.

The audio source, e.g., the speakers, can be selected and/or arranged to convey a message. For example, the speakers can provide one or more tones that convey a message, such as a team association, an affinity, a personal preference, and so on. The audio source can be arranged, e.g., programmed, to provide a tone, a sequence of tones to produce a tune, a pre-recorded and/or otherwise synthesized tune. The tune may include an instantly recognizable portion of a team spirit song, a fight song, a personal favorite song, and so on.

Alternatively or in addition, the audio source can include a voice synthesizer. The voice synthesizer can be programmed or otherwise configured to convey a message. For example, the voice synthesizer can provide a word or phrase of encouragement, instruction, support, motivation, and so on. Alternatively or in addition, the audio source can include a playback of a pre-recorded message. A message can be stored in a memory device, or other suitable media device for playback in association of usage of the message-bearing accessory. The pre-recorded voice message can be a voice of a supportive and/or inspirational figure, such as a coach, a parent, a team member, a friend, a celebrity and/or accomplished athlete. It is envisioned that in at least some embodiments, the message-bearing accessory can include a recording feature to allow for a user to adapt the message-bearing accessory to include a personalized recorded message.

In some embodiments, the message-bearing accessor 700 includes a vibratory source 711. Such a vibrator 711 can be actuated to provide a touch-sensory signal to the player. For example, the vibrator 711 can be activated to provide a pulse or series of pulses to alert or otherwise motivate a player. A series of pulses can be arranged in one or more of number, duration, separation and frequency to convey a particular message. In at least some embodiments, the pulses correspond to a particular message, such as a cheer, a chant, a fight song, and the like. It is understood that the vibrator can be actuated, e.g., by a microphone, to provide vibratory output in response to crowd noise, music, and the like.

In at least some embodiments, the message-bearing accessory 700 includes an actuator 712. The actuator is configured to operate one or more of the message bearing features, such as the lighting arrangement 706 and/or the audio source 710. The actuator 712 can include a manual switch that can be operated, e.g., by a player during play to convey or otherwise receive a message. The manual switch can include a momentary actuation switch that initiates the message upon manual actuation by the user. Alternatively or in addition, the actuator can include other devices, without limitation, such as a pressure sensor, an accelerometer, an environmental sensor, e.g., to determine ambient lighting, ambient noise levels, temperature, humidity. In some embodiments, the environmental sensor can include a biometric sensor, e.g., sensing a biometric indicator of the user. Such biometric indicators can include perspiration, body temperature, pulse, and so on.

One or more of the lighting arrangement 706, the audio source 710 or the vibratory source 711 can be configured alone or in combination to provide an output based on biometric feedback. For example, a motivating feedback by one or more of the message sources 706,710, 711 can be configured to provide a motivating output in response to a biometric feedback that suggests a relaxed state, e.g., relatively low pulse, body temperature, skin surface salinity and/or blood flow of the player. Alternatively or in addition, one or more of the message sources 706,710, 711 can be configured to provide a calming, or focusing output in response to a biometric feedback that suggests an agitated or distressed state, and so on.

It is further envisioned that the message-bearing accessory can include a controller, such as a processor that is operative to portray a predetermined message upon activation. The processor can be programmed, and in some instances reprogrammed, according to one or more of actuation or message conveyance. For example, actuation can be defined according to one or more stimuli alone or in combination. Actuation, or responses to actuation, can be further programmed to consider timing aspects, e.g., time of day, timing of a game situation, time of prior actuations, and so on.

Embodiments of the message-bearing accessory 700 having one or more of the lighting arrangements 406 or the audio source 710 can further include other messages, such as a textual message alone or in combination of any other message types disclosed herein.

It is understood that the message-bearing accessory 700 can include one or more circuit elements operative to activate and/or control one or more of the lighting arrangement 706, the audio source 710 and the vibratory transducer or source 711. By way of non-limiting example, an example circuit is disclosed hereinbelow.

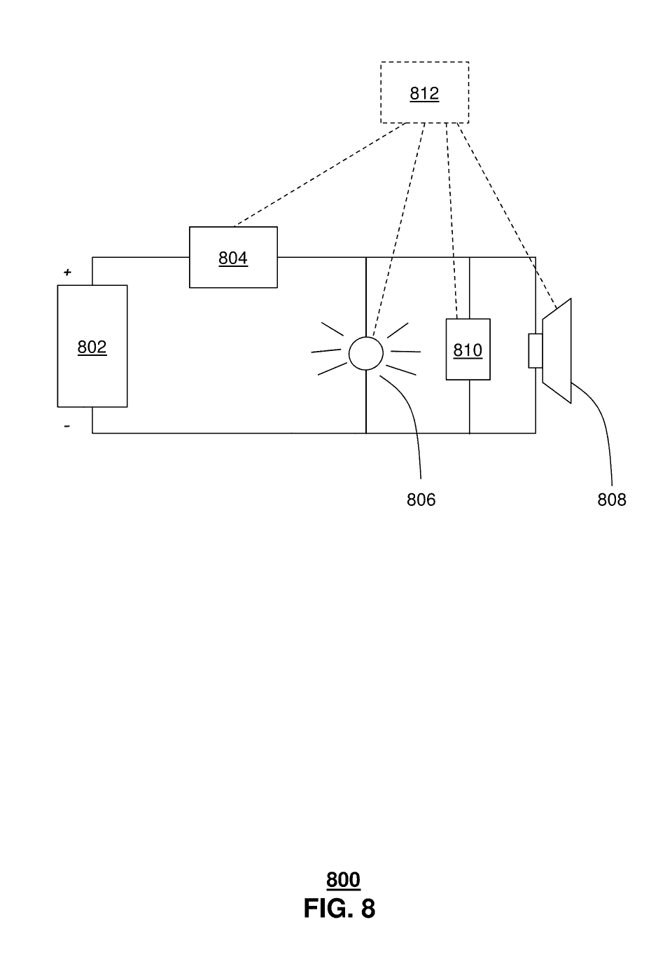

FIG. 8 depicts a schematic diagram of an example of an electrical circuit 800 of the message-bearing accessory 700 of FIG. 7. The simplified schematic diagram of an example circuit 800 includes a power source 802 coupled to one or more of a light circuit 806, a sound circuit 808 and a vibratory circuit 810. At least one actuator 804 is coupled between the power source 802 and one or more of the other circuits 806, 808, 810. In the illustrative example, a single actuator 804 selectively applies power from the power source 802 to each of the other circuits 806, 808, 810. It is understood that other configurations can include multiple actuators, e.g., a first actuator for the light circuit 806 and a second actuator for the sound circuit 808, and so on. The actuators can be the same or different.

In some embodiments, the electrical circuit 800 of the message-bearing accessory includes a controller 812 as disclosed above. An example controller 812 is shown in phantom, in communication with one or more of the actuator(s) 804, the light circuit 806, the sound circuit 808, and/or the vibratory circuit 810.

The illustrations of embodiments described herein are intended to provide a general understanding of the structure of various embodiments, and they are not intended to serve as a complete description of all the elements and features of apparatus and systems that might make use of the structures described herein. Many other embodiments will be apparent to those of skill in the art upon reviewing the above description. For example, message-bearing accessories can be configured for attachment to apparel items, such as jackets, shoes, caps, and the like. Other embodiments, include message-bearing accessories for other items, such as bicycles, vehicles, musical instruments, backpacks, luggage, handbags, tote bags, tools and so on. Other embodiments may be utilized and derived therefrom, such that structural and logical substitutions and changes may be made without departing from the scope of this disclosure. Figures are also merely representational and may not be drawn to scale. Certain proportions thereof may be exaggerated, while others may be minimized. Accordingly, the specification and drawings are to be regarded in an illustrative rather than a restrictive sense.

Customized equipment, such as ball gloves, for example, can cost over $300, with such customization generally being offered on more expensive equipment (gloves). The embodiments disclosed herein provide a new, cost effective and fun way for sports participants to customize their sporting goods equipment. Customization allows players to add their names, jersey numbers and/or other indicia, such as messages, to their equipment. Placing such customization into the players' hands allows them to customize existing and/or used equipment without having to purchase a new glove or piece of equipment. Such customizing can also be used to make one player's equipment easier to find among a sea of other players' equipment, while at the fields or courts.

Although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, can be used in the subject disclosure.

The Abstract of the Disclosure is provided with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

1. A device, comprising:
a supporting member comprising an outer edge and an exposed surface having a shape defined by the outer edge, wherein the shape comprises an elongated straight portion extending along an axis and terminating in a curved portion at one end, wherein the curved portion extends away from the axis, and wherein the elongated straight portion is longer than the curved portion;
a message disposed along the exposed surface of the supporting member; and
an attachment mechanism positioned at a location on the supporting member and configured to attach the supporting member to a personal sports equipment item, wherein one of the attachment mechanism, the location, the shape or a combination thereof are based on a configuration of the personal sports equipment item.

2. The device of claim 1, wherein the supporting member is flexible.

3. The device of claim 2, wherein the supporting member comprises a leather portion.

4. The device of claim 1, wherein the message is one of inspirational, instructional, personal, indicative of an affinity or a combination thereof.

5. The device of claim 4, wherein the message is one of text, color, shape, symbol, sound, vibration, light or a combination thereof.

6. The device of claim 1, wherein the attachment mechanism comprises an aperture that accepts a lace, wherein the lace attaches the supporting member to the personal sports equipment item via the aperture.

7. The device of claim 1, wherein the attachment mechanism comprises one of a button, a snap, a portion of a hook and loop system, a zipper, a staple, a rivet, stitching, an adhesive or a combination thereof.

8. The device of claim 1, further comprising an electrical circuit.

9. The device of claim 8, wherein the electrical circuit comprises a power source, an actuator, and one of a light source, a speaker, a microphone, or a combination thereof.

10. The device of claim 9, wherein the actuator comprises one of a manually operative switch, a pressure sensitive switch, an accelerometer, or a combination thereof.

11. A sports equipment accessory kit, comprising:
a substrate comprising an outer edge and an exposed surface having a shape defined by the outer edge, wherein the shape comprises an elongated straight portion terminating in a curved portion at one end, wherein the elongated straight portion is longer than the curved portion;
a message positionable along the exposed surface of the substrate; and
a fastening mechanism comprising:
a first fastener positioned at a location on the substrate and configured to attach the substrate to a personal sports equipment item; and
a second fastener configured for cooperative engagement with the first fastener to affix the substrate to a personal sports equipment item, wherein one of the fastening mechanism, the location, the shape or a combination thereof are based on a configuration of the personal sports equipment item.

12. The sports equipment accessory kit of claim 11, wherein the substrate comprises a flexible leather member.

13. The sports equipment accessory kit of claim 12, wherein the first fastener comprises a plurality of apertures positioned at respective locations on the substrate and the second fastener comprises a plurality of laces, wherein the cooperative engagement comprises each aperture of the plurality of apertures accepting a lace of the plurality of laces, wherein the plurality of laces attach the substrate to the personal sports equipment item via the plurality of apertures.

14. The sports equipment accessory kit of claim 13, wherein the message is one of inspirational, instructional, personal, indicative of an affinity or a combination thereof.

15. The sports equipment accessory kit of claim 14, wherein the message comprises a plurality of message components attachable to the substrate, wherein the plurality of message components comprises one of text, color, shape, symbol, sound, light.

16. The sports equipment accessory kit of claim 11, wherein the shape of the substrate comprises an elongated portion comprising a curved portion to match a contour of a feature of the personal sports equipment item.

17. The sports equipment accessory kit of claim 16, wherein the substrate comprises a plurality of apertures comprises a first aperture at one end of the elongated portion of the substrate, a second aperture at an opposite end of the elongated portion of the substrate, and a third aperture disposed between the one end and the opposite end of the elongated portion of the substrate.

18. The sports equipment accessory kit of claim 16, wherein the personal sports equipment item comprises one of a softball glove, a baseball glove, or a combined softball/baseball glove and wherein the curved portion matches the contour of a web crotch of the softball glove.

19. An accessorized sports equipment item, comprising:
a sports equipment item; and
a message-bearing accessory removably attached to the sports equipment item, wherein the message-bearing accessory comprises an attachment feature operable to removably attach the message-bearing accessory to the sports equipment item, wherein the message-bearing accessory is removable and replaceable with an alternative message-bearing accessory.

20. The accessorized sports equipment item of claim 19, wherein the sports equipment item comprises one of a glove, a racket, or an item of apparel, and wherein the attachment feature comprises an aperture adapted to accept a lacing to removably attach the message-bearing accessory to the sports equipment item.

21. The accessorized sports equipment item of claim 20, wherein the message-bearing accessory comprises an elongated, flexible member comprising an exposed surface bearing a message.

22. The accessorized sports equipment item of claim 21, wherein the message comprises one of text, color, shape, symbol, sound, light.

23. The accessorized sports equipment item of claim 22, wherein the message comprises one of an inspirational message, an instructional message, a personal message, indicia of an affinity or a combination thereof.
